(19) United States
(12) Patent Application Publication
(10) Pub. No.: US 2007/0133808 A1
(43) Pub. Date: Jun. 14, 2007

(54) Method for allocating session key across gatekeeper zones in a direct-routing mode

(75) Inventors: Kun Li, Shenzhen (CN); Qi Wang, Shenzhen (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: HUAWEI TECHNOLOGIES CO., LTD.

(21) Appl. No.: 11/638,442

(22) Filed: Dec. 14, 2006

Related U.S. Application Data
(63) Continuation of application No. PCT/CN06/00167, filed on Jan. 26, 2006.

(30) Foreign Application Priority Data
Feb. 4, 2005 (CN) 200510005396.X

(51) Int. Cl. H04L 9/30; H04L 9/00; H04K 1/00

(52) U.S. Cl. 380/285; 380/30

(57) ABSTRACT

A method for allocating session key across gatekeepers in a direct-routing mode, including the following steps: a caller's GK and a callee's GK allocate a session key for a caller and a callee between through a Diffie-Hellman (DH) negotiation. The method of the present invention can allocate the session key even when the caller does not support the DH negotiation, therefore it has a wide range of applications.

### FIELD OF THE INVENTION

The present invention relates to authentication technologies between a caller and a callee in a direct-routing mode in a communication system, particularly to a method for allocating a session key across Gatekeeper (GK) zones in a direct-routing mode.

### BACKGROUND OF THE INVENTION

An H.323 system is implemented by a Packet Based Network (PBN) without guarantee on Quality of Service (QoS). Due to its own technical limitation, the PBN is unable to offer QoS or secured services. Therefore in the H.323 system, how to provide real-time and secured services is a problem to be solved.

Versions prior to H.235 protocol V.3 describe some technical solutions on authentication and encryption for the H.323 system, but all of the technical solutions are based on a GK-routing mode. ANNEX I of the H.235 V.3 gives a security solution based on the direct-routing mode, which mainly utilizes the basic features of ANNEX D and ANNEX F of the H.235 V.3 to offer secured service for the communication in the H.323 system, but the implementation of the solution is limited in one GK zone.

In a practical network scenario, an H.323 system usually includes two or more GKs. FIG. 1 is a block diagram illustrating a logical network structure of an H.323 system with two GKs.

As shown in FIG. 1, dotted lines denote transmission paths of Registration, Admission and Status (RAS) messages described in the H.225 in the GK-routing mode; solid lines denote transmission paths of Q.931 messages in the H.225 in the direct-routing mode. End Point (EP) a and EPb are two H.323 EPs, GKg and GKh are two GKs. Wherein, the GKg is the home GK of the EPa, and the GKh is the home GK of the EPb.

When the H.323 system includes two or more GKs, a pre-call appointment mechanism is usually employed to make the EPa and the GKg have a shared key Kag, the EPb and the GKh have another shared key Kbh, and the GKg and the GKh have yet another shared key Kgh, so as to ensure the reliable transmission of the RAS messages.

If the EPa calls the EPb in the direct-routing mode, reliable transmission of the RAS messages is required by both EPs to acquire a session key Kab which is shared between the EPa and the EPb and guarantees the reliable direct transmission of the Q.931 messages in the H.225 between the EPa and the EPb.

In the prior art, there are two methods for the EPa and the EPb to perform authentication with the session key Kab when transmitting the Q.931 messages in the H.225.

Method 1: the GKh generates the session key Kab, the EPa and the EPb perform authentication with the session key Kab generated by the GKh when transmitting the Q.931 messages in the H.225.

Method 2: the caller's GK and the callee's GK perform a Diffie-Hellman (DH) key exchange to generate a session key Kab which is shared between the EPa and the EPb and used for performing authentication in the direct transmission of the Q.931 messages in the H.225 between the EPa and the EPb.

### SUMMARY OF THE INVENTION

The embodiment of the present invention provides a method for allocating session key across Gatekeeper (GK) zones in the direct-routing mode, so as to allocate a session key even when a calling End Point (EP) does not support a Diffie-Hellman (DH) negotiation, and it has a wide range of applications.

The specific solution in accordance with the embodiment of the present invention is as follows:

A method for allocating session key across GK zones in a direct-routing mode includes the following steps:

a caller's GK receiving an Access Request (ARQ) message and performing a DH key exchange process to generate a DH public key;

the caller's GK sending the DH public key to a callee's GK;

the callee's GK receiving the DH public key generated by the caller's GK and generating a DH private key of its own; determining a session key between the caller and a callee through a DH algorithm according to the DH public key generated by the caller's GK and the DH private key generated by the callee' GK; encrypting the session key and sending parameters used in the encryption to the caller's GK through a Location Confirm (LCF) message, and then the caller's GK sending the parameters used in the encryption to the caller;

the callee's GK sending the DH private key generated by itself to the caller's GK; the caller's GK determining the session key between the caller and the callee through the DH algorithm according to the DH private key generated by the callee's GK and the DH public key generated by the caller's GK; encrypting the session key and sending parameters used in the encryption to the caller;

the caller obtaining the session key between the caller and the callee according to the parameters used by the caller's GK, and configuring authentication information in a Setup request with the obtained session key, and sending the Setup request carrying parameters used by the callee's GK to the callee.

It can be seen from the above description that in the method provided by the embodiment of the present invention, only the caller's GK and the callee's GK need to take part in the session key allocation between the caller and the callee, so the session key is only exposed to the caller's GK and the callee's GK. Therefore the long time delay of the information transmission caused by repeated encryptions and decryptions of the session key at intermediate GKs is avoided, and the security problem during the transmission of Registration, Admission and Status (RAS) messages caused by the exposure of the session key at intermediate GKs is also solved. Moreover, the caller needs not support the DH negotiation herein, so the method of the present invention has a wider range of applications.

Other objects and advantages of the invention will become apparent from a consideration of the drawings and ensuing description.

### BRIEF DESCRIPTION OF THE DRAWINGS

FIG. 1 is a block diagram illustrating a logical network structure of an H.323 system with two GKs.

### DETAILED DESCRIPTION OF THE INVENTION

The present invention is hereinafter described in detail with reference to the accompanying drawing and embodiment so as to make the technical solution and advantages of the present invention more clear.

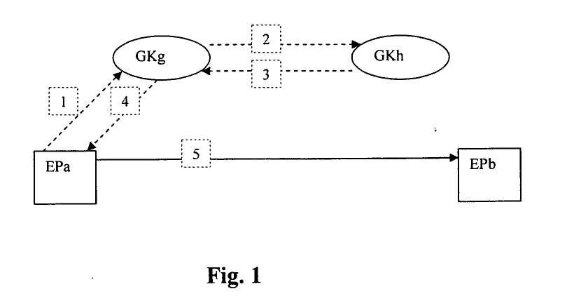

Referring to FIG. 1, EPa and EPb are two H.323 EPs, GKg and GKh are two GKs. Wherein, the GKg is the home GK of the EPa, and the GKh is the home GK of the EPb. First of all, the two methods for the EPa and the EPb to perform authentication with a session key Kab when transmitting the Q.931 messages in the H.225 will be described.

Method 1: the GKh generates the session key Kab, the EPa and the EPb perform authentication with the session key Kab generated by the GKh when transmitting the Q.931 messages in the H.225.

A detailed description of this method is given below: the EPa in FIG. 1 sends an Admission Request (ARQ) to the GKg, the request carries a ClearToken in which a tokenOID filed is of the value “I0”, indicating that the EPa supports the ANNEX I of the H.235 V.3, in other words, the EPa supports the RAS message transmission in GK-routing mode.

After receiving the ARQ message from the EPa, the GKg determines that the EPb is the callee according to the destinationInfo field or the destCallSignalAddress field in the ARQ message, and determines that the EPb is not in the zone of the GKg. So the GKg sends a Location Request (LRQ) to the GKh, inquiring the address of the EPb. An endpointIdentifier field in the LRQ message can carry an Identifier (ID) of the EPa, indicating that it is the EPa that inquires the address of the EPb.

When the GKg receives the ARQ message and finds out that the value of the tokenOID field of the ClearToken in the ARQ message is “I0”, it determines that the EPa supports the ANNEX I of the H.235 V.3 and then generates a ClearToken in the LRQ message of which the tokenOID field is also “I0”. If the GKg does not support the ANNEX I of the H.235 V.3, the GKg needs not to create the ClearToken of which the tokenOID field is “I0” in the LRQ message, and the subsequent information exchange process of the LRQ message is performed in a normal way as that when the ANNEX I of the H.235 V.3 is not supported, in other words, the messages will not be encrypted or decrypted at GKs during transmission.

After receiving the LRQ message, the GKh checks whether the value of the tokenOID of the ClearToken in the LRQ message is “I0”, if the value is “I0”, it indicates that the EPa supports the ANNEX I of the H.235 V.3. If the GKh also supports the ANNEX I of H.235 V.3, the GKh inquires about whether the EPb supports the ANNEX I of the H.235 V.3. If the EPb supports the ANNEX I of the H.235 V.3, the GKh obtains the address of the EPb according to the information of the EPb in the LRQ message.

Then the GKh generates a random number “challenge” as well as a session key Kab for the transmission between the EPa and the EPb. With the random number “challenge” and the shared key Kgh between the GKh and the GKg, the GKh generates an EKgh through a designated key derivation algorithm and encrypts the session key Kab with the EKgh to generate an EKab1. Then the GKh sets the EKab1 and a parameter used in the encryption, such as the random number “challenge”, in a corresponding sub-field of an independent field ClearToken.h235Key.secureSharedSecret.

When there is an endpointIdentifier field in the LRQ message, the GKh also needs to set the EKab1 in a ClearToken.h235Key.secureSharedSecret.generalID field, and set the key derivation algorithm designated for the key generation in a ClearToken.h235Key.secureSharedSecret.keyDerivationOID field, set the random number “challenge” used for the key generation in a ClearToken.challenge field. At the same time, the GKh sets a ClearToken.generalID to be the ID of the GKg, and sets a ClearToken.senderID to be the ID of the GKh, and finally sets the value of tokenOID field in the ClearToken as “I3”. The ClearToken will be hereinafter referred to as CTg.

The GKh generates the key EKbh through the designated key derivation algorithm with another random number “challenge” and the shared key Kbh between the GKh and the EPb, then encrypts the session key Kab with the EKbh to obtain a key, EKab2. After that the GKh sets EKab2 and parameters used in the encryption, such as the designated key derivation algorithm and the second random number “challenge”, in the h235Key.secureSharedSecret field of another ClearToken.

When there is an endpointIdentifier field in the LRQ message, the GKh also needs to set the EKab2 in the ClearToken.h235Key.secureSharedSecret.generalID field and set the second random number “challenge” used for the key generation in the ClearToken.challenge field. And the GKh also sets the ClearToken.generalID field to be the ID of the EPb, the ClearToken.senderID field to be the ID of the GKh, and finally sets the value of tokenOID field in the ClearToken as “I2”. This ClearToken will be hereinafter referred to as CTb.

After the above configurations, the GKh sends a Location Confirm (LCF) carrying the CTb and the CTg to the GKg.

After receiving the LCF message from the GKh, the GKg extracts the independent ClearToken information from the LCF message. If there are at least two ClearTokens, and the value of the tokenOID of one of the ClearTokens is “I3”, indicating that the ClearToken is the CTg; and the value of the tokenOID of the other ClearToken is “I2”, indicating that the ClearToken is the CTb, it is confirmed that both the EPb and the GKh support the ANNEX I of the H.235 V.3 and adopt the H.235 V.3 in security plan.

The GKg generates an Admission Confirm (ACF) message and creates a ClearToken in the ACF message. The value of the tokenOID of the ClearToken is “I1 ”. Then the GKg chooses a third random number “challenge” and sets it in the CTa.challenge field, and obtains the parameters that the CTg used in the encryption, such as the random number “challenge” and the designated key derivation algorithm, so as to decrypt the Ekab1 in the CTg.h235Key.secureSharedSecret field of the LCF message with the key Ekgh derived from the shared key Kgh between the GKg and the GKh through the key derivation algorithm designated by the random number “challenge”, and thereby obtains the session key Kab. The GKg then generates a key EKag with the third random number “challenge” in the CTa.challenge field and a shared key Kag between the EPa and the GKg through a designated key derivation algorithm. After that the GKg encrypts the session key Kab with the key EKag, and sets the encrypted data and the parameters used in the encryption, such as the third random number “challenge” and the designated encryption derivation algorithm, in corresponding sub-fields of the h235Key.secureSharedSecret. The encrypted result of encrypting the Kab with the Ekag and the parameters used in the encryption will be referred to as CTa hereinafter. Finally the GKg copies the CTb.generalID field into the CTa.h235Key.secureSharedSecret.generalID field, copies the CTb into the ACF message, and sends the ACF message carrying the CTb and the CTa to the EPa.

After receiving the ACF message, the EPa extracts the CTa and the CTb, and decrypts the encrypted data in the CTa with the key Ekag derived from the shared key Kag between the EPa and the GKg and through the designated encryption derivation algorithm and the third random number “challenge” in the CTa, so as to obtain the session key Kab.

After obtaining the session key Kab, the EPa establishes a Setup request with the session key and copies the CTb in the ACF message into the Setup request, then the EPa sets authentication information which is described in the ANNEX D of H.235 V.3 in the Setup request with the session key Kab and sends the Setup request via direct route to the EPb.

After receiving the Setup request, the EPb extracts the CTb and deduces the key EKbh according to the CTb.genralID, the CTb.sendersID and the CTb.challenge in the CTb and the shared key Kbh between the EPb and the GKh. Then the EPb decrypts the EKab2 in the CTb.h235Key.secureSharedSecret field of the CTb to obtain the session key Kab.

After obtaining the session key Kab, the EPb authenticates the authentication information in the Setup request, if the authentication succeeds, continue with the Q.931 message transmission.

In the method described above, the session key Kab between the EPa and the EPb is encrypted and decrypted at the GK of every hop, therefore when there are a large number of GKs between the EPa and the EPb, the time delay in the RAS message transmission will increase and since the session key Kab is exposed at the GK of every hop, the information security is poorly maintained.

Method 2: the caller's GK and the callee's GK perform a Diffie-Helman (DH) key exchange to generate a session key Kab which is used for performing authentication in the direct transmission of the Q.931 messages in the H.225 between the EPa and the EPb.

A detailed description of this method is given below: the EPa in FIG. 1 sends an ARQ message to the GKg in which there is an independent ClearToken with a tokenOID of value “I0”. The EPa generates a public key for a DH negotiation, i.e., a DH public key, and sets it in the ClearToken.dhkey field before send the ARQ message to the GKg.

The GKg, which supports the ANNEX I of the H.235 V.3, receives the ARQ message and determines according to the information of the EPb in the ARQ message that the EPb is not in the zone of the GKg. Then the GKg sends to the GKh an LRQ message in which there is an independent ClearToken with a tokenOID of value “I0” and the ClearToken.dhkey field is identical with the ClearToken.dhkey field in the ARQ message, i.e., includes the DH public key generated by the EPa for the DH negotiation.

When there are other GKs between the GKg and the GKh, these intermediate GKs duplicate the LRQ message after receiving the LRQ message and send the duplicated LRQ message to the next GK until the LRQ message reaches the GKh.

After receiving the LRQ message, the GKh determines that both the EPa and the EPb support the ANNEX I of the H.235 V.3 according to the ClearToken.tokenOID field and the information of the EPb in the LRQ message. Then the GKh creates a ClearToken with a tokenOID of the value “I2”. The ClearToken is referred to as CTb hereinafter.

The GKh generates a public key for the DH negotiation, i.e., a DH public key, and further generates a session key Kab with the public key just generated and the public key in the received LRQ message through DH algorithm for the direct transmission of Q.931 messages between the EPa and the EPb.

The GKh then generates a random number “challenge” and sets it in the CTb.challenge field. After that the GKh deduces a key EKbh and a key KSbh through the designated key derivation algorithm on the basis of the random number “challenge” and the shared key Kbh between the EPb and the GKh. The GKh generates a random initialization vector IV and sets it in the CTb.h235Key.securitySharedSecret.paramS.IV field. The GKh encrypts the session key Kab with the key EKbh, the key KSbh and the initialization vector IV to obtain an ENC_{EKbh, KSbh, IV}(Kab), and sets the ENC_{EKbh, KSbh, IV}(Kab) in the CTb.h235Key.securitySharedSecret.encryptedSessionKey field. Such method for encrypting the session key Kab is described in the ANNEX I of H.235 V.3.

The GKh sends an LCF message including the DH public key generated by itself and the CTb generated by the GKh to the GKg.

The GKg receives the LCF message from the GKh, obtains the CTb and the DH public key generated by the GKh, copies them into an ACF message, and sends the ACF message to the EPa.

After receiving the ACF message, the EPa deduces the session key Kab through the DH algorithm based on the DH public key generated by the GKh in the dhkey field of the ACF message and the DH public key of the EPa.

After obtaining the session key Kab, the EPa establishes a Setup request with the session key Kab and copies the CTb in the ACF message into the Setup request, then the EPa sets up authentication information which is described in the ANNEX D of the H.235 V.3 in the Setup request with the session key Kab, and sends the Setup request to the EPb.

The EPb receives the Setup request and extracts the CTb. Based on the information in the CTb, which are the random number “challenge”, the designated key derivation algorithm, and the shared key Kbh between the EPb and the GKh, the EPb deduces the key EKbh and the key KSbh, then decrypts the ENC_{EKbh, KSbh, IV}(Kab) in the CTb.h235Key.secureSharedSecret.encryptedSessionKey field with the EKbh, the KSbh and the initialization vector IV in the CTb to obtain the session key Kab. Finally the EPb authenticates the Setup request with the session key Kab.

The second method described above overcomes the time delay in the RAS message transmission and the security problem generated by the exposure of session key Kab at GK of every hop, but the method requires that the EPa, EPb and all the GKs between the EPa and the EPb support the DH negotiation, which limits its application.

In order to allocate a session key when a caller does not support a DH negotiation, the DH negotiation is performed between a caller's GK and a callee's GK to allocate the session key for the caller and the callee to transmit the Q.931 messages in the embodiment of the present invention.

The method of the embodiment is applicable to the direct-routing mode across GK zones in an H.323 system, in other words, applicable to the situation in which the caller and the callee belong to different GKs and the direct information exchange between the caller and the callee is performed in an insecure network, such as an Internet Protocol (IP) network.

The premise of the implementation is that a GK authenticates all the RAS messages of the EPs in its zone during the allocation of the session key; the EPs authenticate the RAS messages of the home GK so as to maintain a mutual trust between EPs and their home GKs; and the interlinked GKs authenticate each other to avoid a hostile attack and maintain a mutual trust among the interlinked GKs. The above authentication processes may guarantee the security of RAS messages between the network entities in the H.323 system.

The EP can indicate whether it supports the ANNEX I of the H.235 V.3 to its home GK during GK discovery or EP registration process, i.e., indicate whether it supports the method of the embodiment of the present invention. For example, the EP can carry an independent ClearToken in a Gatekeeper Request (GRQ) message or a Registration Request (RRQ) message, and set the value of a tokenOID field in the ClearToken to be “I0”. When the home GK of the EP receives the GRQ message or the RRQ message, it recognizes the value of the tokenOID field in ClearToken being “I0”, and returns a Gatekeeper Confirm (GCF) message or a Registration Confirm (RCF) message to accept the EP. Wherein, the GCF message or the RCF message carries a ClearToken which is identical with that in the GRQ message or the RRQ message.

A preferred embodiment is hereinafter given to further describe the present invention.

The present embodiment is described still with reference to the accompanying FIG. 1.

When the EPa needs to call the EPb using the direct-routing mode, the EPa sends an ARQ message to the GKg.

Wherein, a destinationInfo field in the ARQ message includes information of the EPb, and the ARQ message also includes an independent ClearToken; the value of the tokenOID field of the ClearToken can be set as “I0” and other fields in the ClearToken remain unused, indicating that the EPa supports the ANNEX I of the H.235 V.3.

After the configuration, the EPa sends the ARQ message to the GKg.

After receiving the ARQ message, the GKg determines that the callee is the EPb and the EPb is not in the GK zone of itself according to the information of the EPb in the ARQ message. Then the GKg sends an LRQ to the GKh, inquiring the address of the EPb. Since a DH negotiation is needed between the GKg and the GKh to allocate the session key Kab, the GKg generates a DH public key of its own, and sends the generated DH public key and information to be negotiated with the GKh for the DH negotiation along with the LRQ message to the GKh.

The GKg can set the DH public key of itself in a dhkey field of the ClearToken in the LRQ message, meanwhile it can set the value of the tokenOID field of the ClearToken to be “I4”, indicating that the DH negotiation with the GKh is required. After the above configurations, the GKg sends the LRQ message to the GKh.

If there are multiple GKs between the GKg and the GKh, the GKg sends the LRQ message to an upper GK. The upper GK duplicates the LRQ message and sends the duplicated LRQ message to another GK in the same way, until the LRQ message reaches the GKh.

The GKh receives the LRQ message, recognizes that the value of the tokenOID of the ClearToken in the LRQ message is “I4”, and determines to perform the DH negotiation with the GKg to allocate the session key Kab. The GKh performs the DH negotiation with the GKg to allocate the session key Kab between the EPa and the EPb. The detailed description of negotiation is given hereinafter.

Firstly, the GKh generates a DH private key, and generates the session key Kab using the DH algorithm by taking the generated DH private key and the DH public key obtained from the LRQ message as parameters.

Secondly, the GKh encrypts the session key following the method described in the ANNEX I of H.235 V.3 to create a ClearToken, and sets the value of the tokenOID field of the ClearToken to be “I2”. This ClearToken is referred to as CTb.

Finally, the GKh generates an LCF message which includes the CTb and an independent ClearToken, wherein, the value of the tokenOID field of the ClearToken is “I5”, and the DH private key generated by the GKh is set in the dhkey field of the independent ClearToken. Wherein, “I5” is an identifier for the DH negotiation between the caller's GK and the callee's GK, and other fields in the independent ClearToken remain unused.

After the above-mentioned configurations, the GKh sends the LCF message to the GKg.

If there are multiple GKs between the GKg and the GKh, the GKh sends the LCF message to an upper GK. The upper GK duplicates the LCF message and sends the duplicated LCF message to another GK in the same way, until the LCF message reaches the GKg.

After receiving the LCF message, when recognizing that the value of the tokenOID of the independent ClearToken in the LCF message is “I5”, the GKg obtains the DH private key generated by the GKh from the dhkey filed of the independent ClearToken in the LCF message, and generates the session key Kab by the DH algorithm according to the DH private key generated by the GKh and the DH public key stored by itself.

The GKg creates a ClearToken following the method described in the ANNEX I of H.235 V.3, and sets the value of the tokenOID of the ClearToken to be “I1”. This ClearToken is referred to as CTa.

The GKg generates an ACF message, and transmits the ACF message carrying the CTa and the CTb in the LCF message to the EPa.

the EPa receives the ACF message, obtains the CTa in the ACF message and obtains the session key Kab following the method described in the ANNEX I of the H.235 V.3.

The EPa creates a Setup request, copies the CTb received in the ACF message into the Setup request, and sets authentication information for the Setup request with the session key Kab following the method described in the ANNEX D and ANNEX F of the H.235 V.3.

The EPa sends the Setup request to the EPb in the direct-routing mode.

The EPb receives the Setup request, obtains the CTb from the Setup request, and obtains the session key Kab following the method described in the ANNEX I of the H.235 V.3. Then the EPb authenticates the authentication information in the Setup request with the session key. If the authentication is succeed, the session key Kab is determined as the session key for the transmission of the Q.931 messages between the EPa and the EPb in the direct-routing mode.

The follow-up calling procedure between the EPa and the EPb can be processed following the descriptions in the ANNEX D and ANNEX F of the H.235 V.3.

Although the present invention is described through the foregoing embodiment, those skilled in the art may make numerous changes and variations on the method of the present invention without departing from the spirit and the protection scope thereof, therefore any change or variation within the technical scope disclosed by this invention should be covered by the protection scope of the present invention.

What is claimed is:

1. A method for allocating a session key across Gatekeeper (GK) zones in a direct-routing mode, comprising:
a caller's GK receiving an Access Request (ARQ) message and generating a Diffie-Hellman (DH) public key for a DH key exchange process;
the caller's GK sending the DH public key to a callee's GK;
the callee's GK receiving the DH public key generated by the caller's GK and generating a DH private key of its own; determining a session key between the caller and the callee through a DH algorithm according to the DH public key generated by the caller's GK and the DH private key generated by the callee's GK; encrypting the session key and sending parameters used in the encryption to the caller's GK through a Location Confirm (LCF) message, and the caller's GK sending the parameters used in the encryption to the caller;
the callee's GK sending the DH private key generated by itself to the caller's GK; the caller's GK determining the session key between the caller and the callee through the DH algorithm according to the DH public key generated by the caller's GK and the DH private key generated by the callee's GK; the caller's GK encrypting the session key and sending parameters used in the encryption to the caller;
the caller obtaining the session key between the caller and the callee according to the parameters used by the caller's GK; configuring authentication information in a Setup request with the obtained session key, and sending the Setup request carrying the parameters used by the callee's GK to the callee.

2. The method according to claim 1, wherein the ARQ message carries an independent ClearToken with a tokenOID field, the value of the tokenOID field is set to be “I0”;
before the caller's GK generates the DH public key of its own, it confirms that the value of the tokenOID field of the ClearToken in the ARQ message is “I0”.

3. The method according to claim 1, wherein the step of the caller's GK sending the generated DH public key to the callee's GK comprises: the caller's GK sending a Location Request (LRQ) message to the callee's GK, wherein, the LRQ message carries the DH public key generated by the caller's GK and information which needs a DH negotiation with the callee's GK.

4. The method according to claim 3, wherein the information which needs the DH negotiation with the callee's GK is carried in a tokenOID field of the LRQ message, and the DH public key generated by the caller's GK is carried in a dhkey field of the tokenOID field in the LRQ message.

5. The method according to claim 1, wherein, the step of the caller' GK generating a DH public key for a DH key exchange process comprises:
the caller's GK generating the DH public key according to the information which needs the DH negotiation with the callee's GK in the LRQ message.

6. The method according to claim 1, wherein, the step of sending parameters used in the encryption to the caller's GK and the caller's GK sending the parameters used in the encryption to the caller comprises:
the callee's GK encrypting the determined session key between the caller and the callee to obtain a CTb which comprises the parameters used in the encryption;
the callee's GK sending the LCF message to the caller's GK, wherein, the LCF message carries the CTb and an identifier of the DH negotiation between the caller's GK and the callee's GK;
the caller's GK determining to perform the DH negotiation according to the identifier of the DH negotiation between the caller's GK and the callee's GK in the LCF message, and obtaining the CTb in the LCF message;
the caller's GK sending the CTb to the caller.

7. The method according to claim 6, wherein, the identifier of the DH negotiation between the caller's GK and the callee's GK is “I5”; and
the identifier of the DH negotiation between the caller's GK and the callee's GK is carried in the tokenOID field of the ClearToken in the LCF message.

8. The method according to claim 6, wherein the CTb is carried by an Admission Confirm (ACF) message, and is sent to the caller by the caller's GK.

9. The method according to claim 1, wherein, the step of sending the parameters used in the encryption by the caller's GK to the caller comprises:
the caller's GK encrypting the determined session key between the caller and the callee to obtain a CTa which comprises the parameters used in the encryption; sending the CTa to the caller; the caller obtain the session key determined by the caller's GK between the caller and the callee according to the CTa.

10. The method according to claim 9, wherein, the CTa is carried in the ACF message, and is sent to the caller by the caller's GK.

11. The method according to claim 1, further comprising:
before the step of the caller's GK receiving the ARQ message, the caller and the callee carrying information which indicates that the caller and the callee support the ANNEX I of the H.235 V3 in the ClearToken in a Gatekeeper Request (GRQ) message or a Registration Request (RRQ) message, and sending the GRQ message or the RRQ message to the caller's GK and the callee's GK respectively.

12. The method according to claim 1, further comprising:
after the step of the caller sending the configured authentication information and the parameters used by the callee's GK to the callee through the Setup request, the callee obtaining the session key according to the parameters used by the callee's GK in the Setup request, and authenticating the authentication information in the Setup request; if the authentication is succeed, the callee determining that the obtained session key is the session key for the transmission between the caller and the callee in the direct-routing mode.
